(19) United States
(12) Patent Application Publication
(10) Pub. No.: US 2022/0048161 A1
(43) Pub. Date: Feb. 17, 2022

(54) METAL BOND GRINDSTONE FOR HARD AND BRITTLE MATERIAL

(71) Applicant: NORITAKE CO., LIMITED, Nagoya-shi, Aichi (JP)

(72) Inventors: Daiki FURUNO, Nagoya-shi (JP); Ibuki SHINKAI, Nagoya-shi (JP); Masaru YAMAGUCHI, Nagoya-shi (JP)

(73) Assignee: NORITAKE CO., LIMITED, Nagoya-shi, Aichi (JP)

(21) Appl. No.: 17/425,889

(22) PCT Filed: Jan. 24, 2020
(86) PCT No.: PCT/JP2020/002631

§ 371 Date: Jul. 26, 2021

(30) Foreign Application Priority Data
Feb. 1, 2019 (JP) 2019-017499

(51) Int. Cl. B24D 3/10; C09K 3/14

(52) U.S. Cl. CPC B24D 3/10; C09K 3/14

(57) ABSTRACT

A metal bond grindstone grinds a hard and brittle material. The metal bond grindstone includes: a metal bond; abrasive grains bound by the metal bond; and pores having a pore size of 50-200 μm, such that a porosity in an entirety of the metal bond grindstone is 50-65 vol %. A number of the abrasive grains on a grinding surface excluding the pores may be 700-6500 grains/cm². The abrasive grains may be diamond abrasive grains, and a grain size of the abrasive grains may be 4-20 μm in median size. The metal bond grindstone may have a grindstone strength of 40-95 MPa.

### TECHNICAL FIELD

The present invention relates to a long-life grindstone capable of grinding a hard and brittle material with high efficiency.

### BACKGROUND ART

In recent years, as efforts for effective use of energy have expanded, a SiC power device or the like, which are compact in size and capable of controlling a large amount of electric power, have been attracting attention. With increase of demand for the SiC power device or the like, it has become desirable to grind a high hardness material such as SiC wafer, for example, a high hardness material having Vickers hardness HV1 of 20 Gpa or more, Young's modulus of 400 GPa or more and fracture toughness value of 10 MPa·m^{1/2} or less, with high efficiency. In a conventional machining process, a milling operation is made for cutting an ingot material, and a lapping operation is then made for eliminating undulation. After the milling operation and the lapping operation, another lapping operation or a grinding operation is made for machining flat surfaces, and finally a polishing operation is made for flattening each of the surfaces. Further, a lapping operation or a grinding operation is made for a bottom surface of a wafer on which a device is disposed. Conventionally, since there has been small demand for the operation for grinding the high hardness material such as the SiC wafer, a long time could have been taken to complete the grinding operation for the high hardness material. However, as a result of expansion of a market for the power device, a highly-efficient and long-life grindstone has become required for grinding a hard and brittle material such as SiC substrate, which is used as a material for the power device, from viewpoint of improving productivity and reducing production cost.

As the grindstone used for grinding the hard and brittle material such as SiC or the like, it has been common to use a porous vitrified grindstone as disclosed in Patent Document 1. However, such a porous vitrified grindstone, which has a concentration ratio of 100 or more, provides a sustainability of cutting performance, but does not provide sufficient service life because of removal of abrasive grains that are held with a weak holding force. On the other hand, a metal bond grindstone as disclosed in Patent Document 2, which is constituted by mixture of metal particles such as copper, tin, cobalt and nickel and which has high strength and hardness, has a concentration ratio of 50-100, and provides sufficient service life owing to a larger amount of binder (as compared with in a vitrified grindstone), which provides a condensed structure in mechanical property and makes abrasive grains held with a strong holding force, in general. However, where the metal bond grindstone as disclosed in the Patent Document 2 is used for grinding the hard and brittle material, the abrasive grains are not removed and tend to be dulled, so that the metal bond grindstone is disadvantageously poor in sharpness as compared with the vitrified grindstone.

On the other hand, there is proposed a metal bond grindstone for highly brittle material in which the number of abrasive grains and a bonding strength for holding the abrasive grains are controlled, as disclosed in Patent Document 3. In the proposed metal bond grindstone, it is possible to suppress the bonding strength for holding the abrasive grains although the bonding strength is based on a metal bond, and accordingly to enable the abrasive grains to be removed and to suppress the tendency in which the abrasive grains are dulled, thereby obtaining the sharpness.

### PRIOR ART DOCUMENTS

### Patent Documents

Patent Document 1:
Japanese Unexamined Patent Application Publication No. 2017-080847

Patent Document 2:
Japanese Unexamined Patent Application Publication No. 2002-001668

Patent Document 3:
Japanese Unexamined Patent Application Publication No. 2014-205225

### SUMMARY OF THE INVENTION

### Object to be Achieved by the Invention

The metal bond grindstone for highly brittle material disclosed in the Patent Document 3 is advantageous where the abrasive grains are coarse or fine grains each protruding by a large amount and having a grain size ranging from #230 to #600. However, in recent years, since a wafer is required to be ground with reduced damage for the purpose of reducing a time required for machining in the subsequent step, superfine grains having a grain size of, for example, #2000 (i.e., ranging from about 5 μm to 10 μm in median size) have been becoming standard grains as the abrasive grains. In this case, the metal bond, by which the abrasive grains are held at the concentration ratio of 50-100, is a bond solidified from molten metal and having a condensed structure without pores, so that there is a case in which the sharpness is dulled without worn abrasive grains being removed, or a case in which the sharpness is dulled by bond rubbing that is likely to be caused due to absence of the pores for removing chips generated during an operation for grinding a work material. In either of these cases, the highly efficient grinding and the sufficient service life cannot be both realized and the market needs cannot be met.

The present invention was made in view of the background discussed above. It is therefore an object of the present invention to provide a long-life grindstone capable of grinding a hard and brittle material with high efficiency.

In the conventional metal bond grindstone with high strength and hardness, the concentration ratio of the abrasive grains is 50-100, and the metal binder holding the abrasive grains is the bond solidified from the molten metal, so that the structure is condensed without the pores. Various studies made by inventors of the present invention and their collaborators under the above-described situation has revealed that the reason why the highly efficient grinding and the long service life cannot be both realized by the metal bond grindstone is because worn abrasive grains are not removed so that a work material and a surface of the metal bond rub with each other whereby the sharpness becomes dull as a result of increase of grinding resistance. Then, the inventors and their collaborators found out a fact that it is possible to obtain a metal bond grindstone capable of grinding a hard and brittle material such as SiC with stable grinding performance, high efficiency and long service life, by reducing the rubbing between the work material and the surface of the metal bond so as to solve the above-described issue. The present invention was made based on this finding.

### Measures for Solving the Problem

That is, the gist of the present invention is that, in a metal bond grindstone for grinding a hard and brittle material, the metal bond grindstone is characterized by having a pore size of 50-200 μm in diameter, a porosity of 50-65 vol %, 700-6500 grains/cm² as a number of abrasive grains on a grinding surface, and a grindstone strength of 40-95 Mpa.

### Effect of the Invention

According to the metal bond grindstone for hard and brittle material of the present invention, the metal bond grindstone has the pore size of 50-200 μm in diameter, the porosity of 50-65 vol % in the entirety of the metal bond grindstone, 700-6500 grains/cm² as the number of the abrasive grains on the grinding surface, and the grindstone strength of 40-95 Mpa. Owing to the pore size of 50-200 μm in diameter and the porosity of 50-65 vol %, removed ones of the abrasive grains and chips are captured in the pores whereby clogging is suppressed.

Further, owing to the feature in which the pore size of the pores is 50-200 μm and the porosity in the metal bond grindstone for hard and brittle material is 50-65 vol %, it is possible to suppress increase of machining resistance and brittleness of the metal bond, and also to increase a contact surface pressure against a work material, thereby enabling the metal bond grindstone to appropriately perform a grinding operation. Further, since the metal bond has a porous structure as described above, the pores serve as chip pockets for increasing cooling performance and discharging performance of the chips during the grinding operation, and also increasing retreat performance of the metal bond on the grinding surface.

If the pore size is smaller than 50 μm, the pores are crushed by plastic deformation of the metal bond caused during the grinding operation, whereby effect of the pores cannot be assured. On the other hand, if the pore size is larger than 200 μm, a number of the pores is reduced, and the metal bond includes a portion in which a bond matrix is increased whereby a bond rubbing is problematically caused.

If the porosity is smaller than 50 vol %, the metal bond binding the abrasive grains is to be contact at an increased surface thereof with the work material, thereby making it impossible to perform successive machining operations owing to increase of the machining resistance. On the other hand, if the porosity is larger than 65 vol %, there is caused a problem that a sufficient abrasive grain surface, i.e., a sufficient abrasive exposed surface, for grinding the hard and brittle material cannot be assured.

It is preferable that, in the metal bond grindstone for hard and brittle material, the number of the abrasive grains on the grinding surface excluding the pores is 700-6500 grains/cm². Owing to the feature in which the number of the abrasive grains on the grinding surface excluding the pores is 700-6500 grains/cm², it is possible to assure a depth of cutting of the abrasive grains into the work material, thereby enabling the grinding operation to be performed with low load even where the grinding operation is made with a high feed rate. If the number of the abrasive grains on the grinding surface excluding the pores is larger than 6500 grains/cm², with the metal bond grindstone for hard and brittle material having the porous structure as described above, the load acting on each one of the abrasive grains is made small, whereby the cutting depth, i.e., biting depth of the abrasive grains into the work material in the form of the hard and brittle material such as SiC is made so small that the abrasive grains do not bite into the work material. On the other hand, if the number of the abrasive grains on the grinding surface excluding the pores is smaller than 700 grains/cm², there is caused a problem that an amount of the metal bond provided for each one of the abrasive grains is made large whereby change of worn abrasive grains to unworn abrasive grains is impeded. In the present invention, owing to the feature in which the number of the abrasive grains on the grinding surface is 700-6500 grains/cm², the depth of cutting of the abrasive grains into the work material is assured whereby the grinding operation can be performed with low load even where the grinding operation is made with a high feed rate.

Further, it is preferable that the abrasive grains are diamond abrasive grains, and a grain size of the abrasive grains is from 4 μm to 20 μm, more preferably, from 5 μm to 16 μm, in median size. Owing to the feature, it is possible to obtain the metal bond grindstone capable of grinding the hard and brittle material such as SiC with stable grinding performance, high efficiency and long service life. If the grain size of the abrasive grains is larger than, for example, 20 μm in median size, the abrasive grains bite deeply into the work material whereby the work material is damaged much after the grinding operation, thereby resulting in increase of load (machining time) in the subsequent step. If the grain size of the abrasive grains is smaller than, for example, 4 μm in the median size, an amount of protrusion of each of the abrasive grains from the metal bond is made small so that the abrasive grains cannot bite into the work material thereby making it difficult to assure grinding efficiency and sufficient service life that are required in rough machining operation.

Further, it is preferable that the metal bond grindstone for hard and brittle material has a grindstone strength of 40-95 MPa. Owing to the feature, it is possible to assure the grindstone strength that is about two to four-times as large as that of a vitrified grindstone that is to be used for the same purpose as the metal bond grindstone for hard and brittle material, thereby making it possible to prevent unnecessary removal of the abrasive grains and accordingly to perform successive grinding operations with stable load and sharpness. If the grindstone strength is larger than 95 MPa, the abrasive grains of the grindstone are held by a holding force that is made excessively large whereby worn abrasive grains cannot be changed to unworn abrasive grains, thereby resulting in occurrence of the bond rubbing. On the other hand, if the grindstone strength is smaller than 40 Mpa, the holding force by which the abrasive grains of the grindstone are held is reduced excessively, thereby inducing the removal of the abrasive grains and causing the bond rubbing.

### BRIEF DESCRIPTION OF DRAWINGS

FIG. 1 A perspective view showing a metal bond grindstone for hard and brittle material, which is according to an embodiment of the present embodiment.

FIG. 2 An SEM photograph showing an example of the metal bond grindstone for hard and brittle material.

FIG. 3 A process chart explaining a major part of a method of producing a segment-type metal bond grindstone that constitutes the metal bond grindstone for hard and brittle material of FIG. 1.

FIG. 4 A set of views explaining a structure and a grinding effect of the metal bond grindstone for hard and brittle material of FIG. 3, wherein (a) is a schematic view showing the structure of the metal bond grindstone for hard and brittle material, (b) is a schematic view explaining an effect of suppressing a surface contact in a state of grinding of the metal bond grindstone for hard and brittle material, and (c) is a schematic view explaining a chip pocket effect of the pores in the state of grinding of the metal bond grindstone for hard and brittle material.

FIG. 5 A set of views explaining a structure and a grinding effect of a conventional vitrified grindstone, wherein (a) is a schematic view showing breakage of abrasive grains in a state of grinding of the vitrified grindstone, and (b) is a schematic view showing removal of the abrasive grains in a state of grinding of the vitrified grindstone.

FIG. 6 A set of views explaining a structure and a grinding effect of a conventional metal bond grindstone, wherein (a) is a schematic view showing a state in which abrasive grains are not removed although being worn so that the abrasive grains are not caused to cut, and (b) is a schematic view explaining progress of wear of the abrasive grains and a surface contact state of a metal bond in a state of grinding of the metal bond grindstone.

FIG. 7 A view showing results of evaluations made for various kinds of samples of the metal bond grindstone that are different in pore size in a metal bond, for indicating their grinding performances in presence of difference in the pore size in the metal bond.

FIG. 8 A view showing results of evaluations made for various kinds of samples of the metal bond grindstone that are different in porosity in a metal bond, for indicating their grinding performances in presence of difference in the porosity in the metal bond.

FIG. 9 A view showing results of evaluations made for various kinds of samples of the metal bond grindstone that are different in number of abrasive grains on a grinding surface, for indicating their grinding performances in presence of difference in the number of the abrasive grains on the grinding surface.

FIG. 10 A view showing results of evaluations made for various kinds of samples of the metal bond grindstone that are different in grindstone strength, for indicating their grinding performances in presence of difference in the grindstone strength.

### MODE FOR CARRYING OUT THE INVENTION

Hereinafter, there will be described an embodiment of the present invention, in detail with reference to the drawings.

### Embodiment

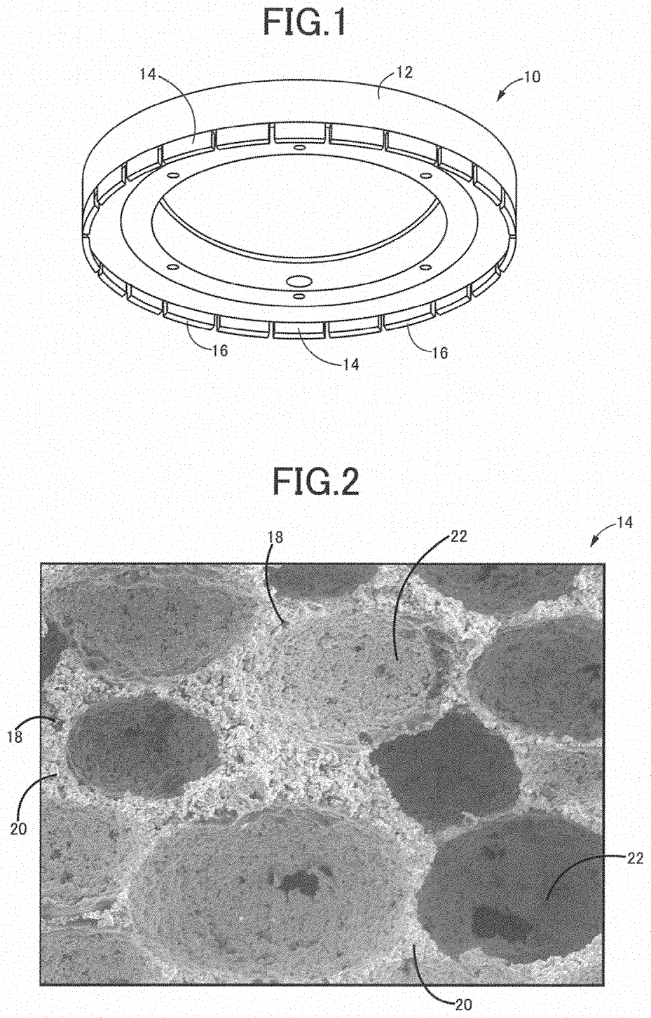

FIG. 1 is a perspective view showing a cup grindstone 10 for hard and brittle material, which is according to the embodiment of the present invention. The cup grindstone 10 includes a disk-shaped base metal 12 made of metal such as aluminum, and a plurality of segment grindstones 14 fixed to a lower surface of the base metal 12 such that the segment grindstones 14 are contiguous to each other and arranged in an annular manner along an outer periphery of the lower surface of the base metal 12. The segment grindstones 14 have respective grinding surfaces 16 that are located on a lower side of an outer peripheral portion of the base metal 12 and contiguous to each other and arranged in an annular manner.

The base metal 12 is constituted by a disk-shaped thick plate made of the metal. With the base metal 12 being attached to a spindle of a grinding machine (not shown), the cup grindstone 10 is to be driven and rotated. The cup grindstone 10 has an outside diameter of about 250 mm. Each of the segment grindstones 14 has a thickness of about 3 mm. When the base metal 12 is rotated, the segment grindstones 14 are brought into sliding contact at the respective grinding surfaces 16 with the hard and brittle material such as SiC wafer and sapphire wafer, so as to grind the hard and brittle material to a flat surface shape.

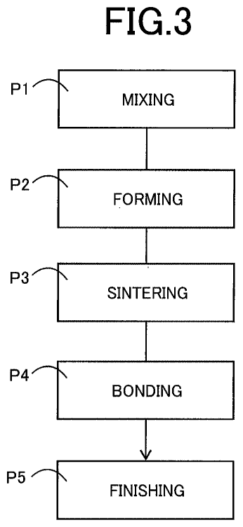

As shown in SEM (scanning electron microscope) photograph of FIG. 2, each of the segment grindstones 14, which corresponds to a metal bond grindstone for hard and brittle material according to the present invention, includes diamond abrasive grains 18, a metal bond 20 by which the diamond abrasive grains 18 are bound, and pores 22 formed in the metal bond 20. In the segment grindstone 14 as the metal bond grindstone, the pores 22 has a pore size which is not smaller than 50 μmφ and is not larger than 200 μmφ such that a porosity is not smaller than 50 vol % and is not larger than 65 vol %, a number of the abrasive grains 18 on the grinding surface 16 is not smaller than 700 grains/cm² and is not larger than 6500 grains/cm², and a grindstone strength is not smaller than 40 MPa and is not larger than 95 MPa. It is noted that the segment grindstone 14 does not necessarily have to be constituted in its entirety by the metal bond grindstone as long as its surface layer serving as a grinding layer is constituted by the metal bond grindstone. The segment grindstone 14 is produced in accordance with a production process shown in FIG. 3 by way of example. The above-described grindstone strength substantially corresponds to a strength of the metal bond that cooperates with the abrasive grains to constitute the grindstone.

In FIG. 3, a mixing step P1 is implemented to prepare the diamond abrasive grains 18 each having a grain size of 4-20 μm, preferably, 5-10 μm in median size, a metal powder material from which the metal bond (metal binder) 20 is to be formed by sintering, and a pore forming agent from which the pores 22 are to be formed in the metal bond 20, such that the diamond abrasive grains 18, the metal powder material and the pore forming agent are prepared at respective predetermined mixing ratios for obtaining the pore size not smaller than 50 μmφ and not larger than 200 μmφ, the porosity not smaller than 50 vol % and not larger than 65 vol %, the number of the abrasive grains not smaller than 700 grains/cm² and not larger than 6500 grains/cm² on the grinding surface 16 and the grindstone strength not smaller than 40 MPa and not larger than 95 MPa. The prepared diamond abrasive grains 18, metal powder material and pore forming agent are mixed homogeneously. The diamond abrasive grains are mixed at the ratio for obtaining a concentration ratio assuring the number of the abrasive grains not smaller than 700 grains/cm² and not larger than 6500 grains/cm² on the grinding surface 16 of the segment grindstone 14. The above-described metal powder material is provided for binding the diamond abrasive grains after the sintering, and is a mixture of a main metal material and an additive material. The metal powder material is referred to as a cobalt bond where the main metal material is cobalt, a steel bond where the main metal material is steel, a tungsten bond where the main metal material is tungsten, a nickel bond where the main metal material is nickel, and a copper bond where the main metal material is copper. The additive material in the form of P (phosphorus), for example, is added to the nickel bond. The additive material in the form of Sn (tin), for example, is added to the copper bond. The pore forming agent is constituted by particles (such as naphthalene, polystyrene and crosslinked acrylic) each having a particle size of 50-200 μmφ in average size and vanishable in the metal bond 20 by burning or melting. The pore forming agent is mixed at the ratio for obtaining the porosity of 50-65 vol %. The above-described median size indicative of the grain size of the diamond abrasive grains 18 is a grain size defined in Japanese Industrial Standards (JIS Z 8825: 2013), and represents a volume-based D50 value measured by a laser diffraction/scattering-type particle-size distribution measuring device (LA-960V2) manufactured by Horiba, Ltd.

A forming step P2 is implemented to fill a forming mold with the mixture material prepared at the mixing step P1, and to form the mixture material, by pressing, to an arcuate shape having substantially the same thickness as the segment grindstone 14. Then, a sintering step P3 is implemented to execute a heat treatment in a furnace at a predetermined sintering temperature of, for example, about 400-900° C., for sintering the metal powder material, whereby the segment grindstone 14 as the metal bond grindstone is produced. Then, a bonding step P4 is implemented to bond the plurality of segment grindstones 14 to the base metal 12 as shown in FIG. 1. Then, a finishing step P5 is implemented to finish the segment grindstones 14 fixed to the base metal 12, by using a dresser.

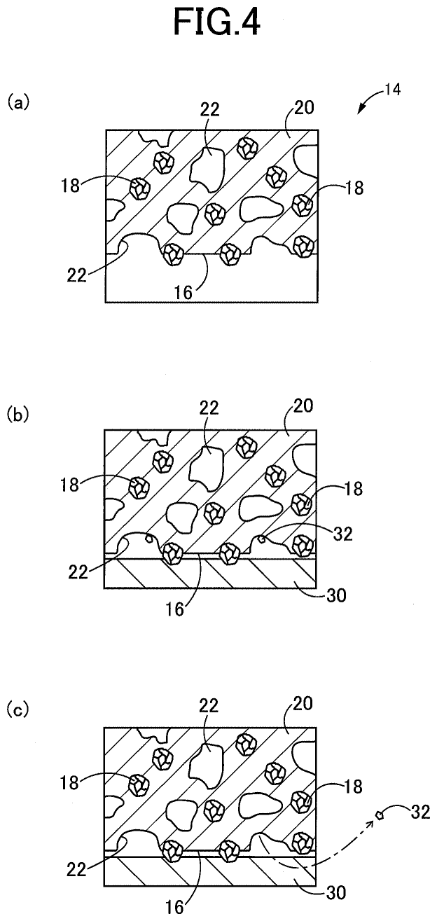

FIG. 4 is a set of schematic views explaining a structure and a grinding effect of the segment grindstone 14, wherein (a) is a schematic view showing the structure of the segment grindstone 14, (b) is a schematic view explaining an effect of suppressing a surface contact of the metal bond 20 in a state of grinding of the segment grindstone 14, and (c) is a schematic view explaining a chip pocket effect of the pores 22 in the state of grinding of the segment grindstone 14. As shown in (a), the metal bond 20 of the segment grindstone 14 includes the diamond abrasive grains 18 and the pores 22, such that the pore size of the pores 22 is 50-200 μmφ and the porosity is 50-65 vol %. Some of the pores 22 open in the grinding surface 16 excluding the pores 22 in the segment grindstone 14 so as to serve as chip pockets. The diamond abrasive grains 18 protrude at a surface density of 700-6500 grains/cm². Owing to the arrangement, as shown in (b) and (c), an area of contact of the metal bond 20 with a work material 30 that is the hard and brittle material such as SiC wafer and sapphire wafer, is reduced whereby a contact surface pressure applied from the abrasive grains 18 to the work material 30 is increased. The ones of pores 22 opening in the grinding surface 16 serve as the chip pockets, so that chips 32 generated during a grinding operation are temporarily received in the chip pockets so as to be discharged from the grinding surface 16, whereby application of a grinding fluid onto the grinding surface 16 is made easy and accordingly cooling of the grinding surface 16 is facilitated.

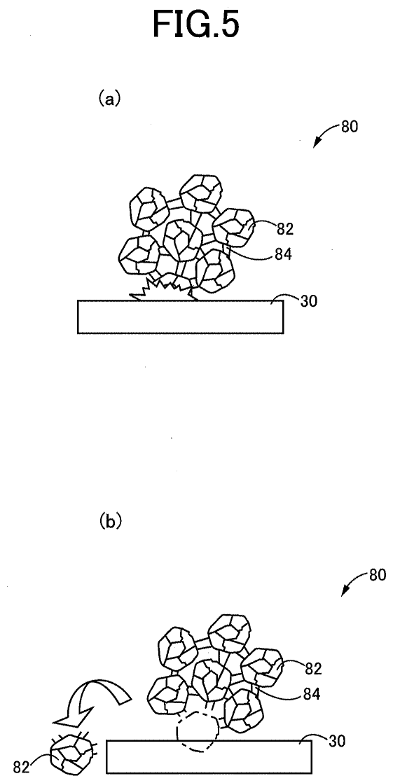

FIG. 5 is a set of views explaining a structure and a grinding effect of a conventional vitrified grindstone 80 as disclosed in the Patent Document 1, wherein (a) is a schematic view showing breakage of abrasive grains in a state of grinding of the vitrified grindstone 80, and (b) is a schematic view showing removal of the abrasive grains in a state of grinding of the vitrified grindstone 80. The vitrified grindstone 80 is a porous grindstone in which the abrasive grains 82 are bound by a vitrified bond 84. In a case in which the vitrified grindstone 80 is used to grind the work material 30 that is the hard and brittle material, since the concentration ratio is not smaller than 100 and the abrasive grains are held with a weak holding force, many of the abrasive grains 82 are removed as shown in FIG. 5(b), with application of load to the abrasive grains 82 as shown in FIG. 5(a), so that the vitrified grindstone 80 cannot provide sufficient service life.

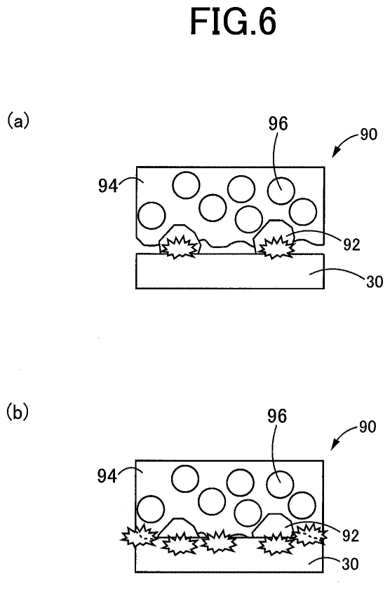

FIG. 6 is a set of views explaining a structure and a grinding effect of a conventional metal bond grindstone 90 as disclosed in the Patent Document 2, wherein (a) is a schematic view showing a state in which abrasive grains 92 are not removed although being worn so that the abrasive grains 92 are not caused to cut, wherein the abrasive grains 92 are bound by a metal bond 94 which is constituted by mixture of metal particles such as copper, tin, cobalt and nickel and which has high strength and hardness, and (b) is a schematic view explaining progress of wear of the abrasive grains 92 and progress of a surface contact of the metal bond 94 in a state of grinding of the metal bond grindstone 90. In a case in which the metal bond grindstone 90 is used to grind the work material 30 that is the hard and brittle material, the metal bond grindstone 90 provides sufficient service life, since the concentration ratio is 50-100 and the stricture is condensed whereby the abrasive grains are held with a strong holding force. However, where the metal bond grindstone 90 is used for grinding a high hardness material, the abrasive grains 92 are not removed even when being broken by application of load thereto as shown in FIG. 6 (a), and tend to be dulled whereby the metal bond 94 is caused to rub at its surface with the work material 30 as shown in FIG. 6 (b), so that the metal bond grindstone 90 is disadvantageously poor in sharpness as compared with the vitrified grindstone 80. It is noted that, although a filler 96 is shown in FIG. 6 (a) and FIG. 6 (b), the filler 96 does not have to be necessarily provided.

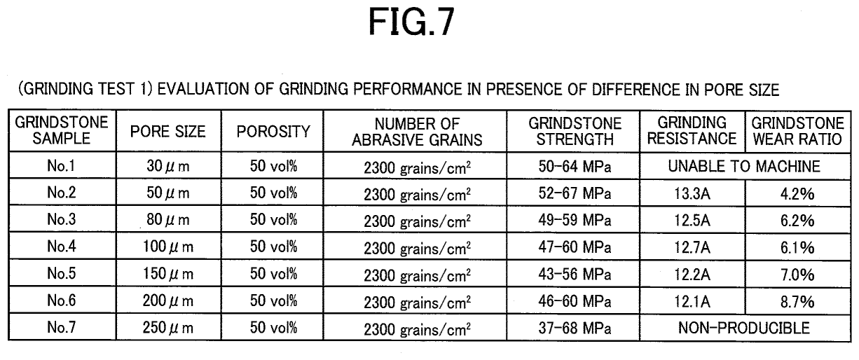

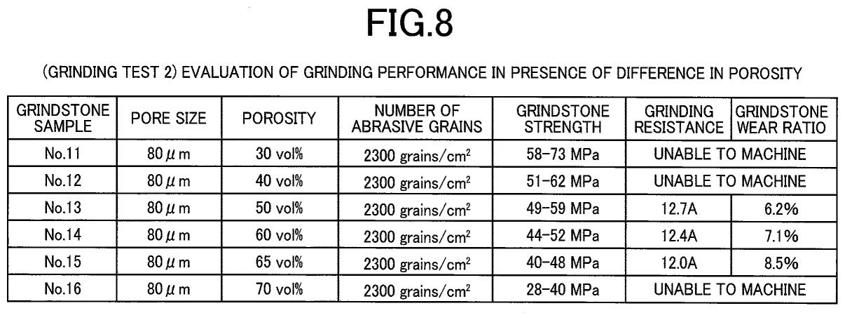

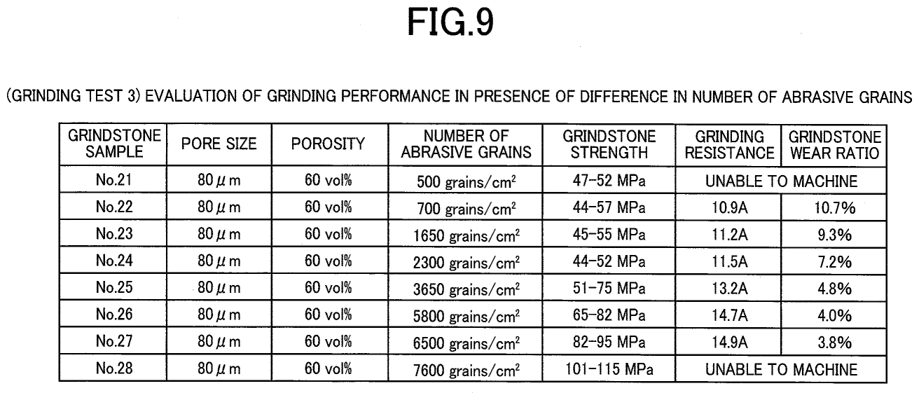

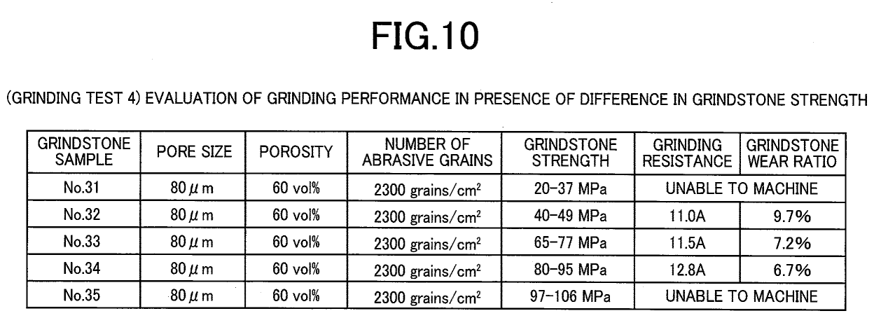

Hereinafter, there will be described a grinding operation test made by the present inventors. FIGS. 7-10 show results of evaluations (grinding resistance and grindstone wear ratio) in grinding tests in which grinding operations were made at a grinding-operation test condition shown in Table 1, by using various kinds of grindstone samples, which were produced in the process shown in FIG. 3 and which include diamond abrasive grains that are 5-10 μm in median size. FIG. 7 shows characteristic values of various kinds of grindstone samples used in “GRINDING TEST 1”, and the results of the “GRINDING TEST 1” in which grinding performances of the respective grindstone samples were evaluated in presence of difference in the pore size in the metal bond. FIG. 8 shows characteristic values of various kinds of grindstone samples used in “GRINDING TEST 2”, and the results of the “GRINDING TEST 2” in which grinding performances of the respective grindstone samples were evaluated in presence of difference in the porosity in the metal bond. FIG. 9 shows characteristic values of various kinds of grindstone samples used in “GRINDING TEST 3”, and the results of the “GRINDING TEST 3” in which grinding performances of the respective grindstone samples were evaluated in presence of difference in the number of abrasive grains on the grinding surface. FIG. 10 shows characteristic values of various kinds of grindstone samples used in “GRINDING TEST 4”, and the results of the “GRINDING TEST 4” in which grinding performances of the respective grindstone samples were evaluated in presence of difference in the grindstone strength.

TABLE 1
Grinding-operation test condition

| Grinding | Surface grinding machine | | |
|---|---|---|---|
| machine | (Infeed type) | | |
| Grinding method | Wet surface grinding | | |
| Workpiece | 4-inch monocrystal | | |
| | SiC wafer | | |
| Machining | Rotational speed of | 2400 | rpm |
| condition | grindstone | | |
| | Rotational speed of wafer | 400 | rpm |
| | Cutting speed | 0.5 | μm/sec. |
| | Machining allowance | 200 | μm |
| Test grindstone | Cup grindstone | 250 | mm in diameter |
| | Segment grindstone | 3 | mm in width |

| | |
|---|---|
| Grinding fluid | City water |

Next, there will be described methods of measuring the pore size (μmφ), porosity (%), number (grains/cm²) of the abrasive grains on the grinding surface, grindstone strength (MPa), grinding resistance (A) and grindstone wear ratio (%) of each of the grindstones. The pore size is an average value in total of 50 pores, wherein the average value was calculated by measuring an average diameter of long and short axes of each of the pores on 10 sheets of enlarged images showing the grinding surface of the grindstone sample in enlargement of 500 times. The porosity is a porosity of a chip-shaped test piece, which was calculated from a calibration curve representing a relationship between a pre-obtained density and the porosity (vol %), wherein the pre-obtained density was calculated from a volume and a weight of the grindstone sample. The number of the abrasive grains is a value obtained by counting a number of the abrasive grains per unit area (cm²) after performing a binarization processing on an enlarged image showing, in enlargement of 500 times, the grinding surface excluding the pores in the grindstone sample. The grindstone strength is an average strength value that leaded to fracture when a three-point bending test was made by using a plurality of grindstone test pieces each having a length of 40 mm, a width of 7 mm and a thickness of 4 mm. The grinding resistance is a drive current value of an electric motor by which the cup grindstone is driven and rotated in the grinding operation made at the grinding-operation test condition shown in Table 1. The grindstone wear ratio represents an amount of wear of the grindstone sample after the grinding operation was made one time at the grinding-operation test condition shown in Table 1.

(Grinding Test 1)

A plurality of pieces (5 pieces) of each of seven kinds of grindstone samples Nos. 1-7 were prepared, wherein the seven kinds of grindstone samples Nos. 1-7 have 30 (μmφ), 50 (μmφ), 80 (μmφ), 100 (μmφ), 120 (μmφ), 200 (μmφ), 250 (μmφ) as the respective pore sizes, while all having 50 (vol %) as the porosity and 2300 (grains/cm²) as the number of the abrasive grains on the grinding surface excluding the pores, as shown FIG. 7. The grindstone strengths of the thus prepared grindstone samples Nos. 1-7 were measured, and the measured grindstone strengths were 37-68 (MPa). Each of the pore size, porosity and number of the abrasive grains shown in FIG. 7 is a target value determined in design process, and is an average value dependent on the mixing ratios. Then, the evaluation was made for each of the grindstone samples Nos. 1-7, by grinding the grindstone samples Nos. 1-7 at the grinding-operation test condition shown in Table 1. As shown in FIG. 7, in the grindstone sample No. 1 having the pore size of 30 (μmφ), the pores 22 were too small to sufficiently provide the chip pocket effect, so that the grinding operation of the monocrystal SiC wafer could not be evaluated. Further, in the grindstone sample No. 7 having the pore size of 250 (μmφ), the pores 22 were so large that an edge portion of the grindstone could be easily chipped, so that it is indicated as “NON-PRODUCIBLE” in FIG. 7. In the grindstone sample No. 7, the grinding operation could not be made although measurements could be made for other portions other than the edge portion. On the other hand, in the grindstone samples Nos. 2, 3, 4, 5 and 6 having 50 (μmφ), 80 (μmφ), 100 (μmφ), 120 (μmφ) and 200 (μmφ) as the respective pore sizes, the grinding resistances were from 12.1 A to 13.3 A and the grindstone wear ratios were from 4.2% to 8.7%, so that excellent performances were obtained in the grinding operation of the monocrystal SiC wafer.

(Grinding Test 2)

A plurality of pieces (5 pieces) of each of six kinds of grindstone samples Nos. 11-16 were prepared, wherein the six kinds of grindstone samples Nos. 11-16 have 30 (vol %), 40 (vol %), 50 (vol %), 60 (vol %), 65 (vol %), 70 (vol %) as the respective porosities, while all having 80 (μmφ) as the pore size and 2300 (grains/cm²) as the number of the abrasive grains on the grinding surface excluding the pores, as shown FIG. 8. The grindstone strengths of the thus prepared grindstone samples Nos. 11-16 were measured, and the measured grindstone strengths were 28-73 (MPa). Each of the pore size, porosity and number of the abrasive grains shown in FIG. 8 is a target value determined in design process, and is an average value dependent on the mixing ratios, as in the grinding test 1. Then, the evaluation was made for each of the grindstone samples Nos. 11-16, by grinding the grindstone samples Nos. 11-16 at the grinding-operation test condition shown in Table 1. As shown in FIG. 8, in each of the grindstone samples Nos. 11 and 12 having the porosity of 30 (vol %) or 40 (vol %), presence of the pores 22 was too small to sufficiently provide the chip pocket effect, so that the grinding operation of the monocrystal SiC wafer could not be evaluated. Further, in the grindstone sample No. 16 having the porosity of 70 (vol %), volume of the pores 22 was so large that grindstone sample No. 16 could not be produced stably, so that grinding operation could not be evaluated. On the other hand, in the grindstone samples Nos. 13, 14 and 15 having 50 (vol %), 60 (vol %) and 65 (vol %) as the respective porosities, the grinding resistances were from 12.0 A to 12.7 A and the grindstone wear ratios were from 6.2% to 8.5%, so that excellent performances were obtained in the grinding operation of the monocrystal SiC wafer.

(Grinding Test 3)

A plurality of pieces (5 pieces) of each of eight kinds of grindstone samples Nos. 21-28 were prepared, wherein the eight kinds of grindstone samples Nos. 21-28 have 500 (grains/cm²), 700 (grains/cm²), 1650 (grains/cm²), 2300 (grains/cm²), 3650 (grains/cm²), 5800 (grains/cm²), 6500 (grains/cm²), 7600 (grains/cm²) as the respective numbers of the abrasive grains per the unit area, while all having 80 (μmφ) as the pore size and 60 (vol %) as the porosity, as shown FIG. 9. The grindstone strengths of the thus prepared grindstone samples Nos. 21-28 were measured, and the measured grindstone strengths were 44-115 (MPa). Each of the pore size, porosity and number of the abrasive grains shown in FIG. 9 is a target value determined in design process, and is an average value dependent on the mixing ratios, as in the grinding test 1. Then, the evaluation was made for each of the grindstone samples Nos. 21-28, by grinding the grindstone samples Nos. 21-28 at the grinding-operation test condition shown in Table 1. As shown in FIG. 9, in the grindstone sample No. 21 having 500 (grains/cm²) as the number of the abrasive grains per the unit area, the number of the pores 22 was too small to sufficiently provide grinding ability, so that the grinding operation of the monocrystal SiC wafer could not be evaluated. Further, in the grindstone sample No. 28 having 7600 as the number of the abrasive grains and 70 (grains/cm²) as the porosity, the number of the abrasive grains per the unit area was so large that the grinding operation of the monocrystal SiC wafer could not be evaluated. On the other hand, in the grindstone samples Nos. 22, 23, 24, 25, 26 and 27 having 700 (grains/cm²), 1650 (grains/cm²), 2300 (grains/cm²), 3650 (grains/cm²), 5800 (grains/cm²) and 6500 (grains/cm²) as the respective numbers of the abrasive grains, the grinding resistances were from 10.9 A to 14.9 A and the grindstone wear ratios were from 3.8% to 10.7%, so that excellent performances were obtained in the grinding operation of the monocrystal SiC wafer.

(Grinding Test 4)

A plurality of pieces (5 pieces) of each of five kinds of grindstone samples Nos. 31-35 were prepared, wherein the five kinds of grindstone samples Nos. 31-35 have 30 (MPa), 40 (MPa), 70 (MPa), 95 (MPa), 105 (MPa) as the respective target values of the grindstone strength, while all having 80 (μmφ) as the pore size, 60 (vol %) as the porosity and 2300 (grains/cm²) as the number of the abrasive grains on the grinding surface. The grindstone strengths of the thus prepared grindstone samples Nos. 21-28 were measured, and the measured grindstone strengths were 20-37 (MPa), 40-49 (MPa), 65-77 (MPa), 80-95 (MPa), 97-106 (MPa), as shown in FIG. 10. Each of the pore size, porosity and number of the abrasive grains shown in FIG. 10 is a target value determined in design process, and is an average value dependent on the mixing ratios, as in the grinding test 1. Then, the evaluation was made for each of the grindstone samples Nos. 31-35, by grinding the grindstone samples Nos. 31-35 at the grinding-operation test condition shown in Table 1. As shown in FIG. 10, in the grindstone sample No. 31 having the grindstone strength of 30 (MPa), the grindstone strength is small and accordingly the strength of the metal bond is small, thereby causing removals of many of the abrasive grains, so that the grinding operation of the monocrystal SiC wafer could not be evaluated. Further, in the grindstone sample No. 35 having the grindstone strength of 105 (MPa), the grindstone strength is large and accordingly the strength of the metal bond is large, thereby resulting in removals of too few of the abrasive grains, so that the grinding operation of the monocrystal SiC wafer could not be evaluated. On the other hand, in the grindstone samples Nos. 32, 33 and 34 having the grindstone strengths of 40 (MPa), 70 (MPa) and 95 (MPa), the grinding resistances were from 11.0 A to 12.8 A and the grindstone wear ratios were from 6.7% to 9.7%, so that excellent performances were obtained in the grinding operation of the monocrystal SiC wafer.

As is clear from the grinding tests 1-4, it is evaluated that the grinding operation of the monocrystal SiC wafer has been excellently performed with the grinding resistance and the grindstone wear ratio being not larger than 15 A and 11%, respectively, where the pore size is not smaller than 50 μm and not larger than 200 μm, the porosity is not smaller than 50 vol % and not larger than 65 vol %, the number of the abrasive grains on the grinding surface 16 is not smaller than 700 grains/cm² and not larger than 6500 grains/cm², and the grindstone strength is not smaller than 40 MPa and not larger than 95 MPa.

As described above, the segment grindstone (metal bond grindstone for hard and brittle material) 14 of the cup grindstone 10 according to the present embodiment has the pore size of 50-200 μm in diameter, the porosity of 50-65 vol % in the entirety of the segment grindstone 14, 700-6500 grains/cm² as the number of the abrasive grains on the grinding surface 16, and the grindstone strength of 40-95 Mpa. Owing to the pore size of 50-200 μm in diameter and the porosity of 50-65 vol %, removed ones of the abrasive grains 18 and the chips 32 are captured in the pores 22 whereby clogging is suppressed.

Further, in the segment grindstone (metal bond grindstone for hard and brittle material) 14 according to the present embodiment, the number of the abrasive grains on the grinding surface 16 excluding the pores 22 is 700-6500 grains/cm². Owing to the feature in which the number of the abrasive grains on the grinding surface 16 excluding the pores 22 is 700-6500 grains/cm², it is possible to assure a depth of cutting of the abrasive grains 18 into the work material 30, thereby enabling the grinding operation to be performed with low load even where the grinding operation is made with a high feed rate. If the number of the abrasive grains on the grinding surface 16 excluding the pores 22 is larger than 6500 grains/cm², with the segment grindstone 14 for hard and brittle material having the porous structure as described above, the load acting on each one of the abrasive grains is made small, whereby the cutting depth, i.e., biting depth of the abrasive grains 18 into the work material 30 in the form of the hard and brittle material such as SiC is made so small that the abrasive grains 18 do not bite into the work material 30. On the other hand, if the number of the abrasive grains on the grinding surface 16 excluding the pores 22 is smaller than 700 grains/cm², there is caused a problem that an amount of the metal bond provided for each one of the abrasive grains is made large whereby change of worn abrasive grains 16 is impeded. In the present invention, owing to the feature in which the number of the abrasive grains on the grinding surface is 700-6500 grains/cm², the depth of cutting of the abrasive grains 18 into the work material 30 is assured whereby the grinding operation can be performed with low load even where the grinding operation is made with a high feed rate.

Further, in the present embodiment, the abrasive grains 18 are diamond abrasive grains, and the grain size of the abrasive grains is 4-20 μm, preferably, 5-16 μm, in median size. Owing to the feature, it is possible to obtain the segment grindstone (metal bond grindstone for hard and brittle material) 14 capable of grinding the work material 30 that is the hard and brittle material such as SiC, with stable grinding performance, high efficiency and long service life. If the grain size of the abrasive grains 18 is larger than, for example, 20 μm in median size, the abrasive grains 18 bite deeply into the work material 30 whereby the work material 30 is damaged much after the grinding operation, thereby resulting in increase of load (machining time) in the subsequent step. If the grain size of the abrasive grains 18 is smaller than, for example, 4 μm in the median size, an amount of protrusion of each of the abrasive grains 18 from the metal bond is made small so that the abrasive grains 18 cannot bite into the work material 30 thereby making it difficult to assure grinding efficiency and sufficient service life that are required in rough machining operation.

Further, the segment grindstone (metal bond grindstone for hard and brittle material) 14 according to the present embodiment has the grindstone strength of 40-95 MPa. Owing to the feature, it is possible to assure the grindstone strength that is about two to four-times as large as that of a vitrified grindstone that is to be used for the same purpose as the metal bond grindstone for hard and brittle material, thereby making it possible to prevent unnecessary removal of the abrasive grains and accordingly to perform successive grinding operations with stable load and sharpness. If the grindstone strength is larger than 95 MPa, the abrasive grains 18 of the segment grindstone are held by the holding force that is made excessively large whereby worn abrasive grains cannot be changed to unworn abrasive grains, thereby resulting in occurrence of bond rubbing. On the other hand, if the grindstone strength is smaller than 40 Mpa, the holding force by which the abrasive grains 18 of the segment grindstone 14 are held is reduced excessively, thereby inducing the removal of the abrasive grains 18 and causing the bond rubbing.

While the embodiment of the present invention has been described in detail with reference to the drawings, the present invention is not limited to details of the embodiment but may be embodied also in other forms.

For example, in the above-described embodiment, the metal bond grindstone for hard and brittle material is constituted by each of the arcuate-shaped segment grindstones 14 fixed to the base material 12. However, the metal bond grindstone for hard and brittle material may be constituted by a disk-shaped metal bond grindstone for hard and brittle material.

Further, the metal bond grindstone for hard and brittle material may be constituted by a part of each of the segment grindstones 14 which is to be involved in the grinding operation, for example, by a grindstone layer that is formed in the part of each of the segment grindstones 14.

It is noted that what has been described above is merely an embodiment of the present invention, and that the present invention may be embodied with various modifications and improvements based on knowledges of those skilled in the art in a range without departing from the spirit of the invention, although the modifications and improvements have not been described by way of examples.

### DESCRIPTION OF REFERENCE SIGNS

10: cup grindstone
12: base metal
14: segment grindstone
   (metal bond grindstone for hard and brittle material)
16: grinding surface
18: diamond abrasive grains
20: metal bond
22: pores
30: work material (hard and brittle material)
32: chips

1. A metal bond grindstone, for grinding a hard and brittle material,
the metal bond grindstone comprising:
a metal bond;
abrasive grains bound by the metal bond; and
pores having a pore size of 50-200 μm, such that a porosity in an entirety of the metal bond grindstone is 50-65 vol %.

2. The metal bond grindstone according to claim 1, wherein a number of the abrasive grains on a grinding surface excluding the pores is 700-6500 grains/cm².

3. The metal bond grindstone according to claim 1, wherein the abrasive grains are diamond abrasive grains, and a grain size of the abrasive grains is 4-20 μm in median size.

4. The metal bond grindstone according to claim 1, having a grindstone strength of 40-95 MPa.
